(19) United States
(12) Patent Application Publication
(10) Pub. No.: US 2017/0081752 A1
(43) Pub. Date: Mar. 23, 2017

(54) Method for Producing a Near Net Shape Metallic Leading Edge

(71) Applicant: Gary L. Hanley, Hobe Sound, FL (US)

(72) Inventor: Gary L. Hanley, Hobe Sound, FL (US)

(21) Appl. No.: 15/271,360

(22) Filed: Sep. 21, 2016

Related U.S. Application Data
(60) Provisional application No. 62/221,251, filed on Sep. 21, 2015.

(51) Int. Cl. C22F 1/18; B33Y 10/00; B33Y 80/00; B23K 15/00; B23K 26/342; B21D 53/84; B23K 26/144; B23K 26/70; B33Y 40/00; B33Y 50/02; F04D 29/38; F04D 29/02; C22C 14/00; B23K 26/00

(52) U.S. Cl. CPC C22F 1/183; C22C 14/00; B33Y 10/00; B33Y 80/00; B23K 15/0086; B23K 15/0093; B23K 26/342; B23K 26/0006; B23K 26/144; B23K 26/702; B33Y 40/00; B33Y 50/02; F04D 29/38; F04D 29/023; B21D 53/84; B23K 2203/14

(57) ABSTRACT

A method for the manufacture of a metallic protective device such as a metal leading edge for a component such as a gas turbine engine composite fan blade, an aluminum alloy fan blade, or other component requiring a metallic protective device. The method can be used to manufacture a near net shape metallic leading edge using a powder bed fusion process. Powder bed fusion technology utilizes a digital three dimensional computer aided design model of a component to manufacture the part with a layer by layer material build-up approach.

### CROSS-REFERENCE

This application claims priority from Provisional Patent Application Ser. No. 62/221,251 filed Sep. 21, 2015.

### FIELD OF THE INVENTION

This invention pertains generally to a process for the manufacture of a net shape or near net shape metallic protective edge device using a powder bed fusion based process, and more particularly to a process for manufacturing a metallic protective leading edge for a gas turbine engine composite and/or aluminum alloy fan blade.

### BACKGROUND

Next generation aircraft engines are designed to be lighter and stronger than engines currently in use by using carbon fiber composites. The application of advanced fiber composites to gas turbine engine fan blades offers several potential advantages. The most significant of these are: 1) elimination of the fan blade mid span shroud which results in improved engine efficiency, 2) lighter engine and aircraft weights which result in reduced fuel consumption, and 3) higher possible blade tip speeds which can reduce the number of fan or compressor stages and result in fewer parts and lower initial and ongoing operational costs.

However, one major problem with the application of advanced fiber composites to fan blade design has been their low resistance to impact in general, and more particularly, their low resistance to bird strike and other foreign object impact damage. Additionally, a major difficulty in predicting impact resistance of composite fan blades has been the limitations of available analysis methods for coping with the complex problem of predicting the local and global dynamic response when subjected to high velocity impact. In order to certify these engines for flight, ballistic impact tests and computational analyses must be completed, which will simulate a bird strike impact, a foreign object impact, and a possible fan blade liberation event. Substantial progress has been made in the application of composite material fan blade technology including improved mechanical properties, design, development, manufacturing and inspection methods which has enabled the expanded use of these composite materials in next generation aircraft engines.

Thus, current composite fan blades generally consist of high strength and modulus fibers embedded in a matrix or bonded to a matrix. Both the fibers and the matrix retain their distinct properties and together they produce desirable properties which cannot be achieved individually. The fibers are the principal load carrying elements in the composite fan blade and the matrix construction provides for a laminate structure generally comprised of several layers of fibers at the desired locations and angles in a matrix that is arranged in a specific manner so as to achieve the desired properties of the composite fan blade.

Although improvements have been made in the design of and the processes employed in the manufacture of composite fan blades, these blades are still subject to foreign object damage by birds, ice balls, ice pieces, rocks, sand, rain and miscellaneous objects such as aircraft tire fragments, in addition to operation with inlet distortion. Accordingly, graphite composite fan blades must be designed and manufactured to tolerate these types of damage, while still safely producing and maintaining the required power for flight operations. In consideration thereof, a requirement still remains for a metallic protective device for turbine engine airfoil surfaces commonly referred to as fan blades, and specifically a metallic protective device for the protection of the composite fan blade leading edge. Thus, composite fan blades will benefit from the application of three dimensional blade composite fiber weaving combined with resin transfer molding technology, which is designed to combine improved fan blade damage tolerance with light weight characteristics.

### SUMMARY

The following presents a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a method for manufacturing a metallic protective device such as a metal leading edge for an airfoil component such as, but not limited to a gas turbine engine composite fan blade or other component(s) that would benefit from a metallic protective device.

The method is used to manufacture a near net shape metallic leading edge for gas turbine engine composite fan blades or other components using a powder bed fusion process. Powder bed fusion technology is a novel method of manufacturing a part such as, but not limited to, a composite fan blade metallic leading edge directly from a digital three dimensional model by using a layer by layer material build-up approach. The present invention novel process is digitally driven directly from a three dimensional computer aided design (CAD) model of the component to be manufactured.

In one preferred embodiment, the method comprises providing a powder bed fusion apparatus; generating a design model of the near net shape metallic leading edge; fixing a substrate on the build platform; filling the powder bed fusion chamber with an inert gas; delivering a layer of powder to the substrate; melting the layer of powder onto the substrate; and allowing the layer of melted powder to solidify. The method further comprises scanning the layer of solidified powder and repeating the process by adding additional layers of powder to complete the near net shape metallic leading edge. The method may optionally decrease a level of oxygen in the powder bed chamber instead of filling the powder bed fusion chamber with an inert gas.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a perspective view of a metallic leading edge protective device and a gas turbine engine composite fan blade that the device is assembled to in accordance with the disclosed architecture.

FIG. 2 illustrates a cross-sectional view of a powder bed fusion device in accordance with the disclosed architecture.

### DETAILED DESCRIPTION

Reference is now made to the drawings, wherein like reference numerals are used to refer to like elements throughout. In the following description, for purposes of explanation, numerous specific details are set forth in order to provide a thorough understanding thereof It may be evident, however, that the novel embodiments can be practiced without these specific details. In other instances, well known structures and devices are shown in block diagram form in order to facilitate a description thereof The intention is to cover all modifications, equivalents, and alternatives falling within the spirit and scope of the claimed subject matter. The invention relates generally to a method of manufacturing a net shape or near net shape metallic leading edge protective device for a leading edge of an airfoil.

As stated previously, the design, application and use of metallic protective devices for gas turbine engine airfoils and composite fan blades has become commonplace. Further, the properties of composite fan blades are highly dependent on the composite ply configuration, matrix material and manufacturing methods. Composite fan blade material design provides the capability to incorporate multiple load paths and/or crack arresting features that prevent delamination or crack propagation to blade failure during the service life of the blade. Composite fan blade geometry is driven primarily by aerodynamics (performance), aeromechanics (stability), impact-fracture (bird strike/foreign object damage), erosion (runway debris including sand, rocks, metal pieces, tire fragments and ice/hail), low cycle fatigue (CF loads) and high cycle fatigue (vibratory response). The present invention discloses next generation gas turbine engines that will employ new process technology known as 3D-woven composite resin transfer molding (RTM) which is designed to combine damage tolerance with light weight characteristics in composite fan blades which will be equipped with a protective metallic leading edge. Other next generation gas turbine engines will utilize aluminum alloy fan blades manufactured from alloys that include but are not limited to aluminum-lithium alloys which will require leading edge erosion and corrosion protection as well as impact-fracture protection. The importance of a metallic leading edge protective device cannot be overstated relative to the protection that the device provides when installed on a composite fan blade leading edge or aluminum alloy fan blade leading edge. The device is a key design component relative to gas turbine engine performance, engine reliability and most importantly, safety of flight.

Prior art processes and practices include but are not limited to press forming, die forging, cold forming, hot forming, hot forging, super plastic forming, machining, fabrication processes, chemical cleaning processes, and additive manufacturing processes in various combinations. A metallic leading edge device designed for a gas turbine engine composite fan blade must exhibit high strength as well as erosion resistance. In addition to high strength, fracture toughness and erosion resistance; the device must also be of a light weight material construction. Although metallic leading edge devices can be manufactured from a wide range of metallic materials including but not limited to aluminum alloys, steel alloys, stainless steel alloys, nickel alloys, cobalt alloys, solution state alloys, precipitation state alloys, a known preferential material is titanium and alloys of titanium. Titanium and titanium alloys are lightweight in comparison to other metallic materials but still possess the fracture toughness and associated material characteristics that are desirable for the manufacture of a protective metallic leading edge device.

When titanium and titanium alloys are used in the manufacture of the device, typically hot forming, superplastic forming and machining are commonly used methods of manufacturing. However, these processes possess inherent problems when applied to the manufacture of a titanium or titanium alloy metallic leading edge. These prior art processes greatly increase the chances of crack initiation, crack formation, oxygen enrichment, Alpha case, surface oxidation, embrittlement, and undesirable grain structure all of which are extremely detrimental to titanium and titanium alloys. These detrimental conditions can cause greatly reduced operational service life, adversely affect performance and even contribute to the catastrophic failure of the device which affects safety of flight. In addition to these concerns, the prior art processes are known to be inefficient and costly by one skilled in the art typically requiring complex tooling and equipment, including but not limited to mandrels, forming apparatus, forming dies, forming presses, die heaters, vacuum systems, machining fixtures and milling equipment.

The present invention is directed to a method of manufacturing a metallic protective device such as a metal leading edge for a component such as, but not limited to, a gas turbine engine composite fan blade or other component(s) requiring a metallic protective device. The present invention addresses known past deficiencies and inefficiencies of prior art associated with the manufacture of such components.

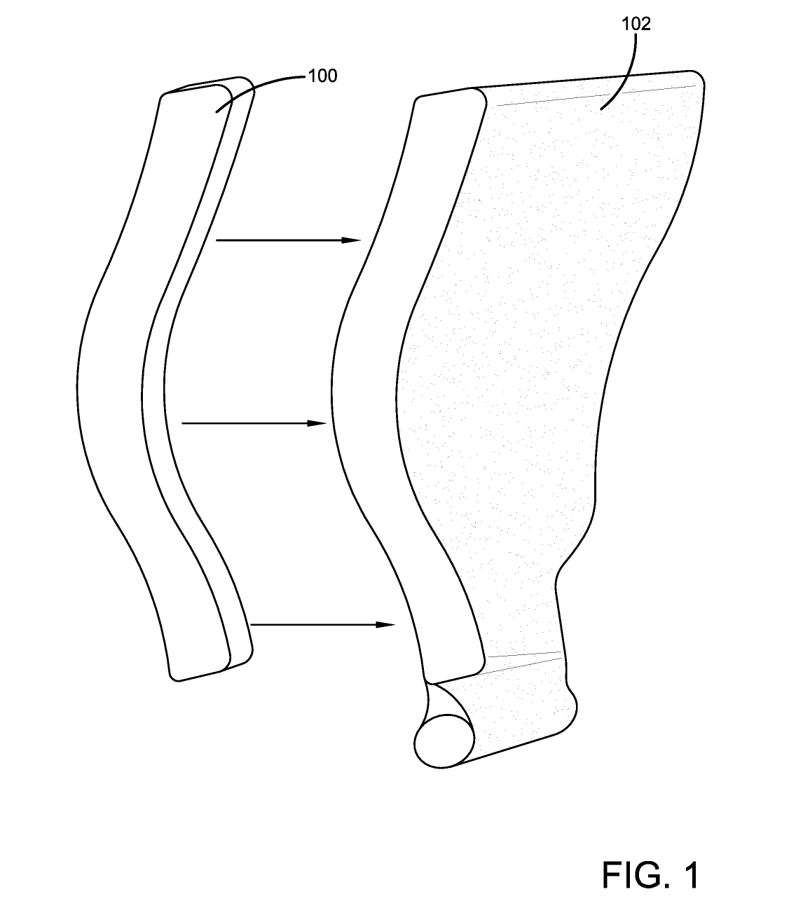

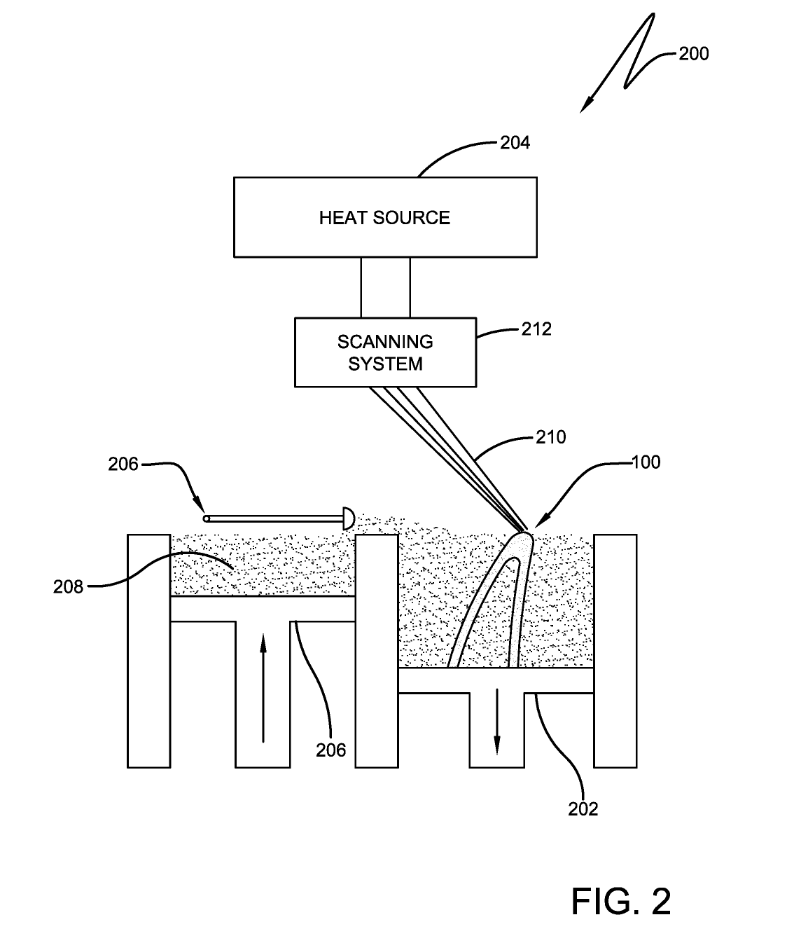

Referring initially to the drawings, FIGS. 1-2 illustrate a method that can be used to manufacture a near net shape metallic leading edge 100 for an airfoil surface 102. The airfoil surface is typically a gas turbine engine composite fan blade 102. However, the method may be used to manufacture a net shape or near net shape metallic leading edge protective device for any surface that would benefit from protection, such as but not limited to composite blades, vanes, surfaces, and the like. The method used a powder bed fusion apparatus 200 to build-up the near net shape metallic leading edge 100 layer by layer using an additive layer manufacturing process from a three dimensional computer aided design (CAD) model of the component to be manufactured as described infra. The method can be used to manufacture the net shape metallic leading edge 100 for a gas turbine engine composite fan blade 102 without the need for traditional tooling devices or systems.

The method forms the near net shape metallic leading edge 100 using the powder bed fusion apparatus 200. The powder bed fusion apparatus 200 comprises a powder bed fusion build chamber 202, a powder delivery system 206, a heat source 204, and a scanning system 212. The powder bed fusion build chamber 202 may comprise a build platform for retaining the near net shape metallic leading edge 100 as it is being constructed.

The method continues wherein the scanning system 212 generates a three dimensional CAD model of the near net shape metallic leading edge 100. Then a substrate, such as but not limited to a base, a support structure, an exoskeleton, and the like, is fixed onto the build platform. Next, the powder bed fusion build chamber 202 may be filled with a protective inert gas atmosphere including, but not limited to, high purity argon gas, or a vacuum in order to provide a protective atmosphere for the molten metal which will form the near net shape metallic leading edge 100. The powder bed fusion build chamber 202 is provided with inert protective atmospheres of argon gas for reactive materials and nitrogen gas for non-reactive materials. Alternatively, the powder bed fusion build chamber 202 may have oxygen evacuated to a maximum of 1200 parts per million instead of utilizing the inert gas. For example, inert gas may be used for laser processing or detrimental oxygen may be evacuated for electron beam processing.

The method uses a powder 208 that may comprise a wide range of metallic alloy powders including, but not limited to, titanium, titanium alloys, nickel alloys, Inconel alloys, cobalt alloys, aluminum alloys, stainless steel alloys and common steel alloys. Inclusion and impurity free titanium powder alloys are particularly desirable for this application. The powder 208 is held in the powder delivery system 206 until needed. The powder delivery system 206 places a layer of the powder 208 on the substrate in the build platform leveled to a predetermined thickness, and the powder 208 is then selectively melted via the heat source 204. The heat source 204 is typically an energy source, such as but not limited to, a laser (light amplification stimulated emission radiation) or electron generator that delivers a beam 210 that completely melts the powder 208 in the path of the beam 210. Once the beam 210 is disengaged, the layer of melted powder solidifies on the substrate.

Once the layer of the powder 208 solidifies, the scanning system 212 scans the layer of solidified powder and compares it to the CAD model of the near net shape metallic leading edge 100. The CAD model may be readily modified to compensate for very thin part cross-sections as required. Then the method is repeated so that a plurality of layers of the powder 208 is deposited on the substrate until the near net shape metallic leading edge 100 is complete. The scanning system 212 controls the beam 204 to precisely melt the plurality of layers of the powder 208 or portions thereof with the heat source 204.

The method may further comprise using the scanning system 212 to scan the solidified layer of the powder 208 surface following a tool path pre-calculated from the CAD model data of the near net shape metallic leading edge 100. The powder 208 may then be selectively re-melted by the beam 210 in a controlled layer by layer methodology as necessary to complete the near net shape metallic leading edge 100. Once completed, the near net shape metallic leading edge 100 may be then heat treated, forged, or surface enhanced by traditional finishing techniques as desited.

The method may further comprise dividing a cross section of each of the plurality of layers of the powder 208 into a plurality of segments which are selected stochastically during scanning with the scanning system 212. This is beneficial as it ensures thermal equilibrium on the layer surfaces thereby reducing component stresses. Another benefit of the method is that a portion of the powder 208 that is not melted and solidified onto the substrate functions as a part support during the build process which provides for complex geometries with high precision and unsupported structures. Additionally, when the substrate is a support structure or exoskeleton, it can be used to support overhanging surfaces, dissipate heat and prevent distortions. A support(s) and/or exoskeleton(s) can be generated during the build process and easily modified during the pre-processing phase. The metallic leading edge build support(s) or exoskeleton can be easily removed by mechanical treatment during the post build phase. Either before or after support or exoskeleton removal, the near net shape metallic leading edge 100 may undergo post-processing treatments to include, but not limited to micro-blasting, peening, polishing, grinding, machining and heat treatment depending on the requirements. For some critical components including, but not limited to, the near net shape metallic leading edge 100, the method may further comprise a hot isostatic pressing process or a forging process or both, to enhance part density, geometry, three dimensional form, surface conditions, and material characteristics if required.

In one embodiment using a titanium Ti-6Al-4V alloy metallic leading edge or other component, a post-build heat treatment of 1025 degrees F. (550 degrees C.) can be applied to improve metallic leading edge ductility while maintaining required component fracture toughness. If a hot isostatic pressing treatment is used, it should be at 14.5 KSI (100 MPa) within the 1650-1750 degree F. (899-954 degrees C.) temperature range for 2-4 hours followed by slow cooling to below 800 degrees F. Resultant tensile properties should be UTS 124-129 KSI (855-889 MPa, depending on direction), YS 110-116 KSI (758-600 MPa) and elongation of +10%. This embodiment can achieve strength levels superior or comparable to conventionally manufactured material to include cast, forged and wrought annealed.

Additionally, the metal powder characteristics provide for proper flow, close packing of particles, and spherical particle shape in order to generate the desired metallic leading edge complex aerodynamic geometries, thin walls, profiles and required material characteristics. The present invention may be used to generate a fully developed homogenous melt pool and fully dense material characteristics upon solidification. The spherical powder size range is closely controlled in order to reduce material usage, increase functionality, consolidate multiple parts and manufacture complex geometries with desired material characteristics. The method can generate part surface finishes in the Ra<⅞ um range comparable to very smooth machine ground finishes.

The method also improves process efficiency by reducing assembly requirements by integrating a number of parts or segments into a single part to include the near net shape metallic leading edge 100. The method can reduce overall component weight, reduce manufacturing time, reduce the number of manufacturing processes required versus the prior art, reduce metallic leading edge or other component cost, reduce material requirements/usage/cost and can optimize the component's required mechanical properties. A conventionally manufactured component as produced by prior art forms can require a number of different manufacturing processes including, but not limited to fabrication, forming, hot forming, superplastic forming, rolling, hot forging, cold forging, extruding, machining, grinding, welding, metallic cladding, laser welding and laser cladding as most commonly used, whereas, the same or like component to include the near net shape metallic leading edge 100 can be produced as a single piece by using the disclosed method which eliminates tooling, reduces required material and can produce the part in a single processing step thereby reducing component cost.

The method further allows complex geometries to include thin wall cross-sections, the reduction or elimination of tooling and fixtures, provides for a “green” process whereby only material that is required is consumed versus costly subtractive manufacturing processes and provides the ability to initiate design changes and modifications in a real time environment without costly tooling considerations. The method provides a regulated manufacturing process that provides accuracy, reliability and repeatability. Process parameters including, but not limited to, energy source power output, material melt pool and layer structure of the metal powder are continuously monitored and documented during the entire manufacturing process. The method may be also used to manufacture the near net shape metallic leading edge 100 with thin wall pressure and suction side features and complex leading edge geometry with precise aerodynamic characteristics and profiles.

Other variations are within the spirit of the present invention. Thus, while the invention is susceptible to various modifications and alternative constructions, a certain illustrated embodiment thereof is shown in the drawings and has been described above in detail.

It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for manufacturing a near net shape metallic leading edge for an airfoil surface, comprising:
providing a powder bed fusion apparatus comprising:
a powder bed fusion build chamber comprising a build platform;
a powder delivery system;
a heat source; and
a scanning system; and
generating a three dimensional computer aided design model of the near net shape metallic leading edge;
fixing a substrate on the build platform;
filling the powder bed fusion build chamber with an inert gas;
delivering a layer of a powder to the substrate via the powder delivery system;
melting the layer of powder onto the substrate with the heat source;
allowing the layer of melted powder to solidify on the substrate;
scanning the layer of solidified powder with the scanning system; and
repeating the process by adding a plurality of layers of the power until the near net shape metallic leading edge is complete.

2. The method of claim 1, further comprising using the scanning system to follow a pre-calculated tool path along the solidified layer of powder and then selectively re-melting the solidified layer of powder in a controlled layer by layer methodology.

3. The method of claim 2, further comprising heat treating the completed near net shape metallic leading edge.

4. The method of claim 3, further comprising forging the near net shape metallic leading edge.

5. The method of claim 3, further comprising enhancing a surface of the near net shape metallic leading edge.

6. A method for manufacturing a near net shape metallic leading edge for an airfoil surface, comprising:
providing a powder bed fusion apparatus comprising:
a powder bed fusion build chamber comprising a build platform;
a powder delivery system;
a heat source; and
a scanning system; and
generating a three dimensional computer aided design model of the near net shape metallic leading edge;
fixing a substrate on the build platform;
decreasing a level of oxygen in the powder bed fusion build chamber;
delivering a layer of a powder to the substrate via the powder delivery system;
melting the layer of powder onto the substrate with the heat source;
allowing the layer of melted powder to solidify on the substrate;
scanning the layer of solidified powder on the substrate with the scanning system; and
repeating the process by adding a plurality of layers of the power until the near net shape metallic leading edge is complete.

7. The method of claim 6, further comprising using the scanning system to follow a pre-calculated tool path along the solidified layer of powder and then selectively re-melting the solidified layer of powder in a controlled layer by layer methodology.

8. The method of claim 7, wherein the powder is a titanium alloy.

9. The method of claim 7, wherein the level of oxygen in the powder bed fusion build chamber is decreased to a maximum of 1200 parts per million.

10. The method of claim 7, wherein the near net shape metallic leading edge is manufactured without tooling or fixtures.

11. The method of claim 7, further comprising enhancing a surface of the near net shape metallic leading edge.

12. A method of additive layer manufacturing for a net shape or near net shape metallic leading edge protective device, comprising:
providing a powder bed fusion apparatus comprising:
a powder bed fusion build chamber comprising a build platform;
a powder delivery system;
a heat source; and
a scanning system; and
generating a three dimensional computer aided design model of the net shape or near net shape metallic leading edge protective device;
fixing a substrate on the build platform;
filling the powder bed fusion build chamber with an inert gas or decreasing a level of oxygen in the powder bed fusion build chamber;
delivering a layer of a powder to the substrate via the powder delivery system;
melting the layer of powder onto the substrate with the heat source;
allowing the layer of melted powder to solidify on the substrate;
scanning the layer of solidified powder with the scanning system;
repeating the process by adding a plurality of layers of the power until the near net shape metallic leading edge protective device is complete;
using the scanning system to follow a pre-calculated tool path along the solidified layer of powder and then selectively re-melting the solidified layer of powder in a controlled layer by layer methodology; and
heat treating the completed near net shape metallic leading edge protective device.

13. The method of claim 12, wherein the inert gas comprises argon or nitrogen.

14. The method of claim 12, wherein the powder is comprised of at least one of the following materials: titanium, substantially inclusion and impurity free titanium alloys, nickel alloys, Inconel alloys, cobalt alloys, aluminum alloys, stainless steel alloys, or common steel alloys.

15. The method of claim 12, further comprising melting only a portion of at least one of the plurality of the layers of powder with the heat source.

16. The method of claim 12, wherein the substrate comprises a support structure or an exoskeleton.

17. The method of claim 12, wherein the completed near net shape metallic leading edge protective device is heated to at least 550 degrees Celsius.

18. The method of claim 12, wherein the heat treating process is a hot iso-static pressing treatment.

19. The method of claim 12, wherein each of the plurality of layers of powder is divided into a plurality of segments selected stochastically to ensure thermal equilibrium and to reduce component stress.

20. The method of claim 12, further comprising accumulating a non-melt portion of the powder within the powder bed fusion build chamber to support the net shape or near net shape metallic leading edge protective device during the manufacturing.
